(19) United States
(12) Patent Application Publication
(10) Pub. No.: US 2023/0125804 A1
(43) Pub. Date: Apr. 27, 2023

(54) METHOD AND APPARATUS FOR SUPPORTING AVAILABLE SERVICES IN WIRELESS COMMUNICATIONS SYSTEMS

(71) Applicant: Samsung Electronics Co., Ltd., Suwon-si (KR)

(72) Inventors: Hoyeon LEE, Suwon-si (KR); Dongeun SUH, Suwon-si (KR)

(21) Appl. No.: 17/973,981

(22) Filed: Oct. 26, 2022

(30) Foreign Application Priority Data
Oct. 27, 2021 (KR) 10-2021-0144593

(51) Int. Cl. H04W 48/14; H04W 48/18; H04W 60/04

(52) U.S. Cl. CPC H04W 48/14; H04W 48/18; H04W 60/04

(57) ABSTRACT

A method performed by a terminal in a wireless communication system is provided. The method includes transmitting, to a network entity, a first message for requesting a registration with a network, receiving, from the network entity, a second message in response to the first message, the second message including information on a tracking area (TA) associated with network slice selection assistance information (NSSAI), identifying single-NSSAI (S-NSSAI) to request based on the second message and location information of the terminal, and transmitting, to the network entity, a third message including the identified S-NSSAI.

### CROSS-REFERENCE TO RELATED APPLICATION(S)

This application is based on and claims priority under 35 U.S.C. § 119(a) of a Korean patent application number 10-2021-0144593, filed on Oct. 27, 2021, in the Korean Intellectual Property Office, the disclosure of which is incorporated by reference herein in its entirety.

### BACKGROUND

### 1. Field

The disclosure relates to a wireless communication system. More particularly, the disclosure relates to a method and apparatus for providing a network slice in a wireless communication system.

### 2. Description of Related Art

5th generation (5G) mobile communication technologies define broad frequency bands such that high transmission rates and new services are possible, and can be implemented in “sub 6 gigahertz (GHz)” bands such as 3.5 GHz, and also in “above 6 GHz” bands such as mmWave including 28 GHz and 39 GHz. In addition, implementation of 6th generation (6G) mobile communication technologies (referred to as “beyond 5G systems”) in terahertz bands (e.g., 95 GHz to 3 terahertz (THz) bands) has been considered for providing transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multi-input multi-output (MIMO) for mitigating radio-wave path loss and increasing radio-wave transmission distances in mmWave, supporting numerologies (e.g., operating multiple subcarrier spacings (SCSs)) for efficiently utilizing mmWave resources and dynamic operation of slot formats, initial access technologies for supporting multi-beam transmission and broadbands, definition and operation of bandwidth part (BWP), new channel coding methods such as a low density parity check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, new radio (NR) user equipment (UE) power saving, non-terrestrial network (NTN), which is UE-satellite direct communication for providing coverage in an area in which communication with terrestrial networks is unavailable, and positioning.

Moreover, there has been ongoing standardization in air interface architecture/protocol regarding technologies such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access (RA) for simplifying RA procedures (e.g., 2-step random access channel (RACH) for NR). There also has been ongoing standardization in system architecture/service regarding a 5G baseline architecture (e.g., service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be implemented. To this end, new research is scheduled in connection with extended reality (XR) for efficiently supporting augmented reality (AR), virtual reality (VR), mixed reality (MR) etc., 5G performance improvement and complexity reduction by utilizing artificial Intelligence (AI) and machine learning (ML), AI service support, metaverse service support, and drone communication.

Further, such development of 5G mobile communication systems will serve as a basis for developing new waveforms for providing coverage in terahertz bands of 6G mobile communication technologies, multi-antenna transmission technologies such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), as well as full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

There may be a case where the single-network slice selection assistance information (S-NSSAI) included in the requested Network Slice Selection Assistance Information (NSSAI) requested by a terminal is not supported by a tracking area (TA) so the single-NSSAI is rejected. For a network slice rejected because the network slice is not supported by a registration area (RA) including the TA, the terminal cannot attempt a registration procedure for the rejected network slice until the terminal leaves the RA.

Aspects of the disclosure are to address at least the above-mentioned problems and/or disadvantages and to provide at least the advantages described below. Accordingly, an aspect of the disclosure is to provide a method for solving the above problems and an apparatus therefor.

Additional aspects will be set forth in part in the description which follows and, in part, will be apparent from the description, or may be learned by practice of the presented embodiments.

In accordance with an aspect of the disclosure, a method performed by a terminal in a wireless communication system is provided. The method includes transmitting, to a network entity, a first message for requesting a registration with a network, receiving, from the network entity, a second message in response to the first message, the second message including information on a tracking area (TA) associated with network slice selection assistance information (NSSAI), identifying single NSSAI (S-NSSAI) to request based on the second message and location information of the terminal, and transmitting, to the network entity, a third message including the identified S-NSSAI.

In accordance with another aspect of the disclosure, a method performed by a network entity in a wireless communication system is provided. The method includes receiving, from a terminal, a first message for requesting a registration with a network, transmitting, to the terminal, a second message in response to the first message, the second message including information on a TA associated with NSSAI, and receiving, from the terminal, a third message including a S-NSSAI to request, wherein the S-NSSAI is identified based on the second message and location information of the terminal.

In accordance with another aspect of the disclosure, a terminal in a wireless communication system is provided. The terminal includes a transceiver, and a processor configured to transmit, to a network entity via the transceiver, a first message for requesting a registration with a network, receive, from the network entity via the transceiver, a second message in response to the first message, the second message including information on a TA associated with NSSAI, identify S-NSSAI to request based on the second message and location information of the terminal, and transmit, to the network entity via the transceiver, a third message including the identified S-NSSAI.

In accordance with another aspect of the disclosure, a network entity in a wireless communication system is provided. The network entity includes a transceiver, and a processor configured to receive, from a terminal via the transceiver, a first message for requesting a registration with a network, transmit, to the terminal via the transceiver, a second message in response to the first message, the second message including information on a TA associated with NSSAI, and receive, from the terminal via the transceiver, a third message including a S-NSSAI to request, wherein the S-NSSAI is identified based on the second message and location information of the terminal.

The technical problems to be achieved in the embodiment of the disclosure are not limited to the technical problems mentioned above, and other technical problems not mentioned herein will be clearly understood from the following description by those skilled in the art to which the disclosure belongs.

According to various embodiments of the disclosure, an apparatus and method for effectively providing a service in a wireless communication system may be provided.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a system structure of a 5th generation system (5GS) according to an embodiment of the disclosure;

FIG. 2 illustrates a network arrangement according to an embodiment of the disclosure;

FIG. 3 illustrates a terminal registration procedure and a configuration information update procedure (UE Configuration Update procedure) according to an embodiment of the disclosure;

FIG. 4 illustrates a terminal registration procedure and a slice update procedure according to an embodiment of the disclosure;

FIG. 5 illustrates a terminal registration procedure according to an embodiment of the disclosure;

FIG. 6 illustrates a view of a structure of a terminal in a wireless communication system according to an embodiment of the disclosure; and

FIG. 7 illustrates a view of a structure of a network entity in a wireless communication system according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness,

The terms and words in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals designate, the same or like elements.

Hereinafter, the disclosure relates to a method and an apparatus for supporting various services in a wireless communication system. Specifically, the disclosure describes a technique for supporting various services by managing terminal registration to use a network slice in a wireless communication system.

Specifically, the disclosure provides a method and apparatus for monitoring by a network entity (e.g., access and mobility management function (AMF)), whether a location of the terminal is changed in units of TAs and notifying the terminal when S-NSSAI, which was not previously allowed, becomes available.

In addition, the disclosure provides a method and apparatus for a terminal to request information on a slice to be monitored to a network entity, and to update slice information based thereon.

In addition, the disclosure provides a method and apparatus for transmitting slice information in units of TAs.

In addition, the disclosure provides a method for configuring TA information associated with S-NSSAI and an apparatus therefor.

As used in the following description, terms for identifying access nodes, terms referring to network entities or network functions (NFs), terms referring to messages, terms referring to interfaces between network entities, terms referring to various identification information, and the like are illustratively used for the sake of convenience. Therefore, the disclosure is not limited by the terms as used below, and other terms referring to subjects having equivalent technical meanings may be used.

For convenience of description, the disclosure uses terms and names defined in a 3rd-generation partnership project long-term evolution (3GPP LTE) and 5G standards. However, the disclosure is not limited by the terms and names, and may be equally applied to a system that is based on another standard.

Hereinafter, for convenience of description, the name of NF (e.g., AMF, session management function (SMF), network slice selection function (NSSF), or the like) is used as a target for exchanging information for access control and state management. However, embodiments of the disclosure can be applied equally even in a case that NF is actually implemented as an instance (which is AMF instance, SMF instance, NSSF instance, or the like, respectively).

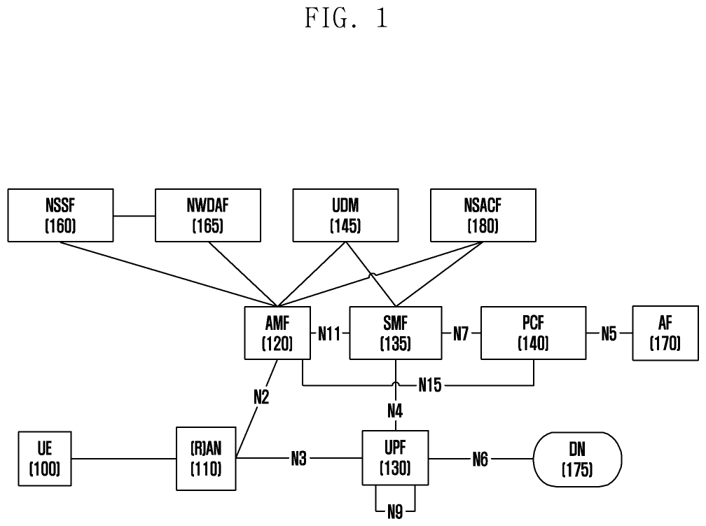

FIG. 1 illustrates a system structure of a 5th generation system (5GS) according to an embodiment of the disclosure.

The 5GS may include a 5G core network, a base station, a terminal, and the like. The 5G core network (or 5GC) may include an access and mobility management function (AMF) 120, a session management function (SMF) 135, a user plane function (UPF) 130, a policy control function (PCF) 140, a user data management (UDM) 145, a network slice selection function (NSSF) 160, a network data analytics function (NWDAF) 165, N3F, an application function (AF) 170, and a data network (DN) 175 or the like.

A terminal 100 may access the 5G core network through a radio access network (base station) 110. The radio access network (base station) 110 may support a 3GPP access network type (e.g., NR, evolved-universal terrestrial radio access (E-UTRA), etc.) or a non-3GPP access network type (e.g., Wi-Fi, etc.). The terminal 100 may be connected to the AMF 120 and an N2 interface through the base station 110, and may be connected to the UPF 130 and an N3 interface.

The base station 110 may be referred to as an ‘access point (AP)’, an ‘eNodeB (eNB)’, a ‘5th generation (5G) node’, a ‘gNodeB (gNB)’, or other terms having equivalent technical meanings to those of the above-described terms, in addition to the base station.

A non-3GPP function (N3F) is a network function (NF) operating as an N2 interface terminal and an N3 interface termination for the terminal 100 accessed through a non-3GPP access network (e.g., WiFi, etc.) not defined in 3GPP. The N3F may process an N2 control plane signaling and an N3 user plane packet.

The access and mobility management function (AMF) 120 is a network function (NF) that manages wireless network access and mobility for a terminal (UE).

The session management function (SMF) 135 is an NF that manages a session for a terminal, and the session information includes quality of service (QoS) information, billing information, and packet processing information.

The user plane function (UPF) 130 is an NF that processes user plane traffic and is controlled by the SMF 135.

The policy control function (PCF) 140 is an NF that manages operator policy for providing services in a wireless communication system.

The user data management (UDM) 145 is an NF that stores and manages UE subscription information.

The unified data repository (UDR) is an NF that stores and manages data. The UDR may store terminal subscription information and provide terminal subscription information to the UDM. In addition, the UDR may store operator policy information and provide operator policy information to the PCF.

The network data analytics function (NWDAF) 165 is an NF that provides analysis information for the operation of 5G systems. The NWDAF may collect data from other NFs or an operations, administration and maintenance (OAM) constituting the 5G system, analyze the collected data, and provide analysis results to other NFs.

The network slice admission control function (NSACF) 180 is an NF that monitors and controls the number of registered terminals and the number of sessions of a network slice that is a target of a network slice admission control (NSAC). The NSACF stores configuration information on the maximum number of registered terminals and the maximum number of sessions for each network slice.

Hereinafter, entities that exchange information for access control and state management will now be collectively called “NFs” for convenience of explanation. However, embodiments of the disclosure may be equally applied to an occasion in a case that the NF is actually implemented as an instance (which is AMF instance, SMF instance, NSSF instance, or the like, respectively).

In the disclosure, an instance may mean a state in which a particular NF exists in the form of software code and can execute physical and/or logical resources allocated from a computing system in order to perform a function of an NF in a physical computing system, for example, a particular computing system existing on a core network. Thus, the AMF instance, the SMF instance, and the NSSF instance may mean capable of using physical and/or logical resources allocated from a particular computing system existing on the core network for an AMF operation, an SMF operation, and NSSF operations, respectively. Consequently, the AMF instance, the SMF instance, and the NSSF instance, which use physical and/or logical resources allocated from a particular computing system existing on the network for AMF, SMF, and NSSF operations, may perform the same operations as in the case of physical AMF, SMF, and NSSF apparatuses. Thus, in embodiments of the disclosure, an item described as an NF (e.g., an AMF, an SMF, a UPF, an NSSF, a network repository function (NRF), a service communication proxy (SCP), etc.) may be replaced with an NF instance, or conversely, an item described as an NF instance may be replaced with an NF and applied.

Likewise, in embodiments of the disclosure, an item described as a network slice may be replaced with a network slice instance, or conversely, an item described as a network slice instance may be replaced with a network slice.

According to one embodiment of the disclosure, in the 5G system defined by the 3GPP, one network slice may be referred to as single-network slice selection assistance information (S-NSSAI). The S-NSSAI may include a slice/service type (SST) value and a slice differentiator (SD) value. The SST may indicate a characteristic of a service supported by the slice (for example, enhanced mobile broadband (eMBB), Internet of things (IoT), ultra-reliable low latency communications (URLLC), vehicle-to-everything (V2X), etc.). The SD may be used as an additional identifier for a specific service referred to as the SST.

The network slice selection assistance information (NSSAI) may be constituted of one or more S-NSSAIs. For example, the NSSAI may include, but are not limited to, a configured NSSAI stored in the terminal, a requested NSSAI requested by the terminal, an allowed NSSAI allowed to be used by the terminal determined by the NF (e.g., AMF, NSSF, etc.) of a 5G core network, subscribed NSSAI where the terminal subscribes, etc.

The terminal 100 may be simultaneously connected to the access network 110 and registered in the 5G system. Specifically, the terminal 100 may access the base station 110 and perform the AMF 120 and a terminal registration procedure. During the registration procedure, the AMF 120 may determine an allowed slice (Allowed NSSAI) available to the terminal accessing the base station 110 and allocate the determined allowed slice to the terminal 100.

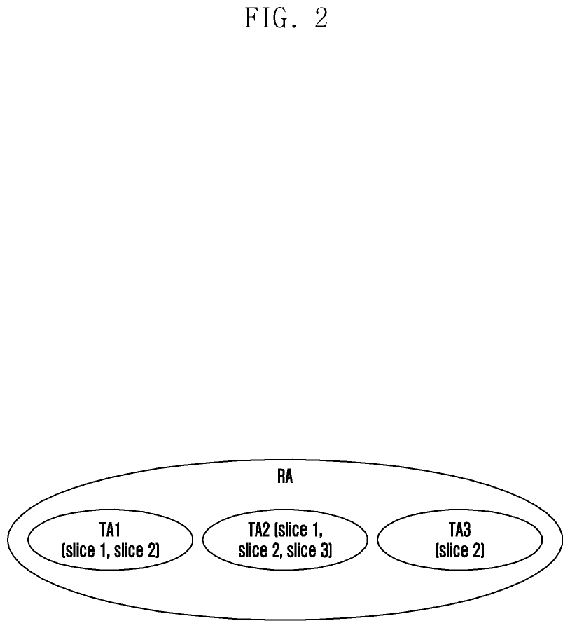

FIG. 2 illustrates a network arrangement according to an embodiment of the disclosure.

A tracking area (TA) may be defined as a unit indicating the location of the terminal in the network. One registration area (RA) may be constituted with one or more TAs.

Referring to FIG. 2, an embodiment in which RA is constituted with TA1, TA2, and TA3 is illustrated. The network may manage slice information that the TA can support (S-NSSAI supported by a TA). For example, with reference to FIG. 2, the TA1 supports slice 1 (S-NSSAI 1) and slice 2 (S-NSSAI 2), and the TA2 supports slice 1 (S-NSSAI 1) and slice 2 (S-NSSAI 2), slice 3 (S-NSSAI 3), and the TA3 supports the slice 2 (S-NSSAI 2).

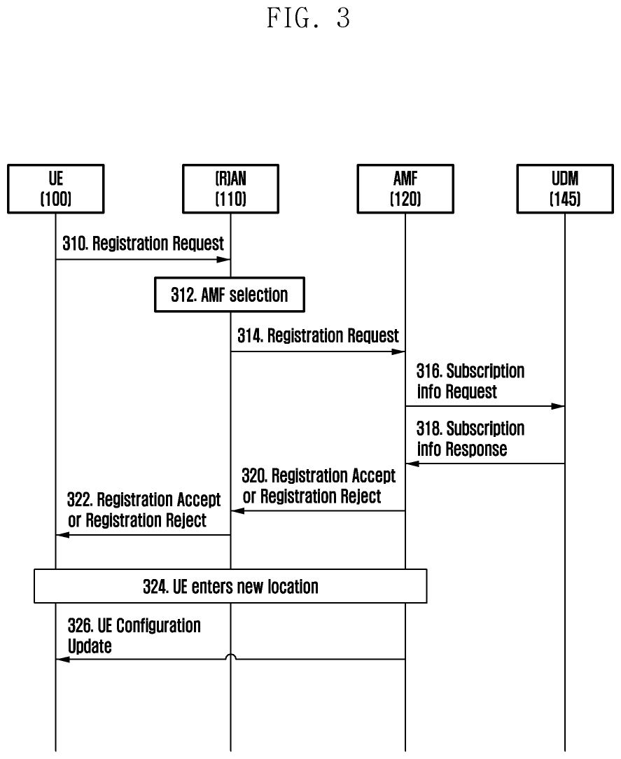

During a terminal registration procedure illustrated in FIG. 3 to be described later, the terminal transmits a requested slice (Requested NSSAI) to be used by the terminal to the network, and the network may transmit a slice allowed to be used by the terminal (Allowed NSSAI) to the terminal. Here, the allowed slice may be determined based on the network arrangement as illustrated in FIG. 2. Details will be described with reference to FIG. 3.

FIG. 3 illustrates a terminal registration procedure and a configuration information update procedure (UE Configuration Update procedure) according to an embodiment of the disclosure.

Some of the steps of FIG. 3 may be omitted, or two or more steps may be combined and performed as one step. In addition, the operation sequence of FIG. 3 may be changed in some cases.

Referring to FIG. 3, the terminal 100 (user equipment (UE)) according to an embodiment of the disclosure may access the base station 110 and perform a registration procedure with the AMF 120.

In step 310, the terminal 100 may access the base station 110 and transmit a Registration Request message to the base station 110. For example, the Registration Request message may include a requested slice (Requested NSSAI, e.g., S-NSSAI 1, S-NSSAI 2) to be used by the terminal. In addition, the Registration Request message may include location information (e.g., Tracking Area Identity (TAI), Cell Identity, etc.) of the terminal.

In step 312, the base station 110 that has received the Registration Request message may select an AMF to transmit the Registration Request, based on the requested slice (Requested NSSAI) received from the terminal 100. For example, the base station 110 may select an AMF capable of supporting the requested slice (Requested NSSAI).

In step 314, the base station 110 may transmit an N2 message to the AMF 120 selected in step 312. For example, the N2 message may include the Registration Request message. Also, the N2 message may include N2 parameters. The N2 parameters may include location information (e.g., tracking area identity (TAI), cell identity, etc.) of the terminal. The AMF 120 may need to obtain terminal subscription information in order to process the Registration Request message.

In step 316, the AMF 120 may request the terminal subscription information to the UDM 145. The terminal subscription information request message may include a terminal identifier (ID) (e.g., subscription permanent identifier (SUPI), 5G-globally unique temporary identifier (GUTI), etc.).

In step 318, the UDM 145 may transmit the terminal subscription information corresponding to the terminal ID to the AMF 120 in response to the request of AMF 120. The terminal subscription information may include slice information subscribed by the terminal 100 (subscribed S-NSSAIs). For example, the slice information to which the UE subscribes may include at least one of S-NSSAI 1, S-NSSAI 2, S-NSSAI 3, or S-NSSAI 4.

In step 320, based on at least one of a terminal requested slice (Requested NSSAI), a terminal subscribed slice (subscribed S-NSSAIs), a terminal access network (3GPP AN), a network slice supported by the base station 110 (S-NSSAI supported by RAN), or an operator policy, the AMF 120 may determine an allowed slice (Allowed NSSAI).

For example, the AMF 120 may identify whether the terminal requested slice (e.g., S-NSSAI 1 and S-NSSAI 2) is included in the terminal subscribed slice (e.g., S-NSSAI 1, S-NSSAI 2, S-NSSAI 3 and S-NSSAI 4). In addition, the AMF 120 may identify whether the terminal requested slice (e.g., S-NSSAI 1 and S-NSSAI 2) is included in the network slice supported by the base station 110 (e.g., S-NSSAIs supported by TA2 includes S-NSSAI 1, S-NSSAI 2, and S-NSSAI 3) at the current location (e.g., TA2) of the terminal.

The AMF 120 may determine to put a slice which is included in both (i) the terminal subscribed slice (e.g., S-NSSAI 1, S-NSSAI 2, S-NSSAI 3, and S-NSSAI 4) and (ii) the slices to be supportable at the current location of the terminal (e.g., S-NSSAI 1, S-NSSAI 2, and S-NSSAI 3), among the terminal requested slice (e.g., S-NSSAI 1 and S-NSSAI 2), into an allowed slice (e.g., S-NSSAI 1 and S-NSSAI 2).

In addition, the AMF 120 may determine the RA during the terminal registration processing procedure. The RA may be constituted with TAs at the current location of the terminal and the TAs adjacent to the current location. For example, the RA may be constituted with TA1, TA2, and TA3. The AMF 120 may identify whether the slice (e.g., S-NSSAI 1, S-NSSAI 2) that is determined to be included in the allowed slice is supported by all TAs (e.g., TA1, TA2, TA3) included in the RA. If all TAs included in the RA support the slice to be determined in the allowed slice, the AMF may finally decide to include the corresponding slice in the allowed slice. In a case that at least one TA included in the RA does not support the slice determined to be included in the allowed slice (for example, in a case that the TA3 included in the RA supports S-NSSAI 2 but does not support S-NSSAI 1), the AMF may finally decide not to include the corresponding slice in the allowed slice. In other words, even in a case that a slice is supported by some of the TAs included in the RA (e.g., S-NSSAI 1 is supported by TA1 and TA2), but this slice is not supported by all TAs (e.g., S-NSSAI 1 is not supported by TA3).), the AMF may finally decide not to include the corresponding slice in the allowed slice. That is, the finally determined allowed slice may include only slices supported by all TAs (e.g., S-NSSAI 2). In addition, the AMF may determine to include the slice (e.g., S-NSSAI 1) not included in the allowed slice in a rejected slice (rejected S-NSSAI).

According to another embodiment, in a case that the terminal is located in the TA3, the AMF 120 may identify whether the terminal requested slice (e.g., S-NSSAI 1 and S-NSSAI 2) is included in the terminal subscribed slice (e.g., S-NSSAI 1, S-NSSAI 2, S-NSSAI 3, and S-NSSAI 4). In addition, the AMF 120 may identify whether the terminal requested slice (e.g., S-NSSAI 1 and S-NSSAI 2) is included in the network slice supported by the base station 110 (e.g., S-NSSAIs supported by TA3 includes S-NSSAI 2) at the current location (e.g., TA3) of the terminal.

The AMF 120 may determine to include a slice, among the terminal requested slice (e.g., S-NSSAI 1 and S-NSSAI 2), into the allowed slice (e.g., S-NSSAI 2), where the slice is included in both (i) the terminal subscribed slice (e.g., S-NSSAI 1, S-NSSAI 2, S-NSSAI 3, and S-NSSAI 4) and (ii) the slice included in the slice supportable at the current location of the terminal (e.g., S-NSSAI 2).

In addition, the AMF 120 may determine the RA during the terminal registration processing procedure. The RA may be constituted with the TAs at the current location of the terminal and the TAs adjacent to the current location of the terminal. For example, the RA may be constituted with TA1, TA2, and TA3. The AMF 120 may identify whether the slice (e.g., S-NSSAI 2) determined to be included in the allowed slice is supported by all TAs (e.g., TA1, TA2, TA3) included in the RA. If all TAs included in the RA support the slice determined to be included in the allowed slice, the AMF may finally decide to include the corresponding slice in the allowed slice. In a case that the slice determined to be included in the allowed slice is not supported by at least one TA included in the RA, the AMF may finally decide not to include the corresponding slice in the allowed slice. That is, the finally determined allowed slice may include only the slice supported by all TAs (e.g., S-NSSAI 2). In addition, the AMF may determine to include the slice (e.g., S-NSSAI 1) not included in the allowed slice in the rejected slice (rejected S-NSSAI).

The AMF 120 may store at least one of the requested slice received from the terminal 100, the allowed slice determined by the AMF, and the rejected slice as a UE context.

In order to describe embodiments of the disclosure, the embodiment will be described assuming that the terminal is located in TA3 and performs the registration procedure.

The AMF 120 may transmit, to the terminal 100, a response message (e.g., Registration Accept or Registration Reject message) in response to the Registration Request message received in step 314. The Registration Accept message may include at least one of a first allowed slice (Allowed NSSAI) and a first rejected slice (rejected NSSAI). In addition, the Registration Accept message may include the first RA information available for the allowed slice. If there is no slice available to the terminal, that is, if there is no allowed slice, the AMF 120 may transmit a Registration Reject message.

In step 322, the base station 110 may transmit the Registration Accept or Registration Reject message received from the AMF 120 to the terminal 100.

The terminal 100 that has received the Registration Accept message may store the first allowed slice and/or the first rejected slice in the Registration Accept message. The terminal 100 may establish a protocol data unit (PDU) session using the first allowed slice at a first RA location.

In step 324, the current location of the terminal may be changed due to the movement of the terminal 100. For example, the terminal that has performed the Registration Request procedure of steps 310 to 322 at the location TA3 may move thereafter and be located at the TA2.

The AMF 120 may detect a change in the location of the terminal. For example, the AMF 120 may request and receive current location information (e.g., TAI, Cell Identity, etc.) of the terminal from the base station 110.

In step 326, the AMF 120 may determine the change of the allowed slice based on the current location information of the terminal. For example, the AMF may identify that at least some (e.g., S-NSSAI 1, S-NSSAI 2) of the rejected slice (e.g., S-NSSAI 1) transmitted to the terminal in steps 320 to 322 (the rejected slice may be stored in the AMF as a UE context) and the requested slice requested by the terminal in step 314 (the requested slice may be stored in the AMF as a UE context) can be supported at the current location TA2 of the terminal. Accordingly, because the rejected slice (e.g., S-NSSAI 1) that has been rejected during the previous registration procedure can be supported at the current location, the AMF may determine to include the corresponding slice in the allowed slice.

In addition, the AMF may determine an RA (e.g., a second RA) to which the allowed slice is applicable. For example, the AMF may include S-NSSAI 1 and S-NSSAI 2 in the second allowed slice, and the second RA may be constituted with the TAs capable of supporting all S-NSSAI included in the allowed slice. In this case, the second allowed slice may include S-NSSAI 1 and S-NSSAI 2, and the second RA may include TA1 and TA2. TA3 may not be included in the second RA because the TA3 does not support S-NSSAI 1. Since S-NSSAI 1 included in the first rejected slice is included in the second allowed slice, the AMF may determine a new rejected slice (second rejected slice). That is, the AMF may exclude S-NSSAI 1 included in the first rejected slice from the rejected slice. In this case, since slice information included in the first allowed slice and the second allowed slice is different, the AMF may transmit a UE Configuration Update message including the second allowed slice to the terminal.

Alternatively, for example, the AMF may include S-NSSAI 2 in the second allowed slice and the second RA may be constituted with TAs capable of supporting all S-NSSAIs included in the allowed slice. In this case, the second allowed slice may include S-NSSAI 2, and the second RA may include TA1, TA2, and TA3. In this case, since the first allowed slice and the second allowed slice are the same, the AMF may not transmit the UE Configuration Update message.

The AMF 120 may transmit the UE Configuration Update message to the terminal 100 in order to transmit a new allowed slice (the second allowed slice). The UE Configuration Update message may include a second allowed slice. In addition, the UE Configuration Update message may include the second RA. In addition, the UE Configuration Update message may include a second rejected slice.

The AMF 120 may update the UE context information stored in step 320. For example, the AMF 120 may store the second allowed slice as the allowed slice allowed to the terminal 100 and store the second rejected slice as the rejected slice.

As an example, the UE configuration update message may be transmitted to the terminal through the base station 110. The terminal 100 that has received the UE Configuration update message may store the second allowed slice and/or second rejected slice included in the UE Configuration update message. The terminal 100 may establish a PDU session using the second allowed slice at the second RA location.

Through the procedure illustrated in FIG. 3 according to an embodiment of the disclosure, in a case that the slice (e.g., S-NSSAI 1) that has not been available at the previous location (e.g., TA3) of the terminal is available at the current location (e.g., TA2) of the terminal, the AMF may transmit a new allowed slice to the terminal 100.

Through the procedure illustrated in FIG. 3 according to the embodiment of the disclosure, in a case that the slice (e.g., S-NSSAI 1) that has not been available at the previous location (e.g., TA3) of the terminal is available at the current location (e.g., TA2) of the terminal, the terminal may receive a new allowed slice from the AMF and use the received new allowed slice.

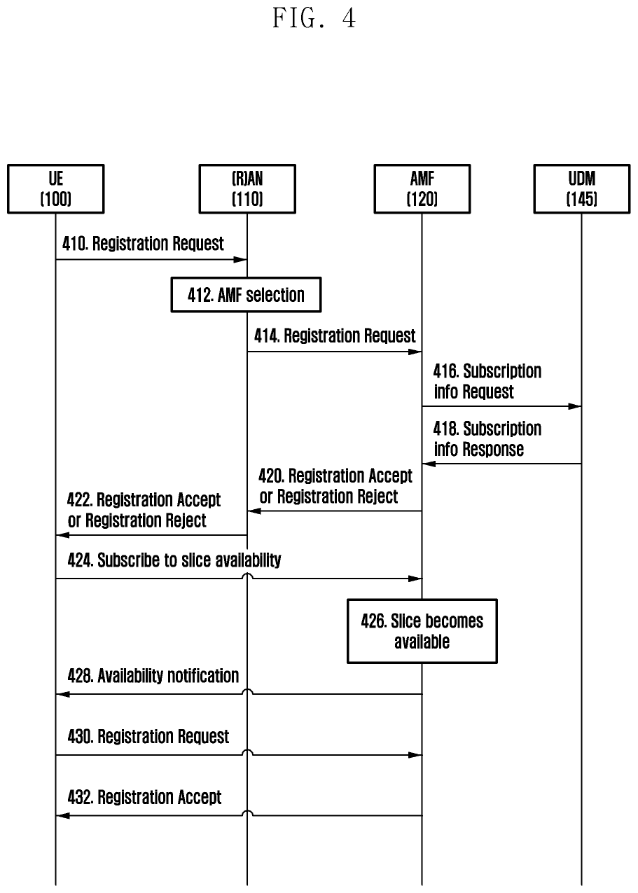

FIG. 4 illustrates a terminal registration procedure and a slice update procedure according to an embodiment of the disclosure.

Referring to FIG. 4, the terminal 100 according to an embodiment of the disclosure may access the base station 110 and perform a registration procedure with the AMF 120.

Some of the steps of FIG. 4 may be omitted, or two or more steps may be combined and performed as one step. In addition, the operation sequence of FIG. 4 may be changed in some cases.

Steps 410 to 422 of FIG. 4 may correspond to steps 310 to 322 of FIG. 3 described above, respectively, and the description of each step is the same. Therefore, the overlapping description will be omitted.

In step 424, the terminal 100 may perform an event subscription for whether a slice is available. The terminal 100 may transmit a slice availability subscription request message to the AMF 120. For example, the slice availability subscription request message may include S-NSSAI information, which is a target to a slice availability event subscription that the terminal intends to request. In addition, the S-NSSAI information included in the slice availability subscription request message may be included in at least one of Configured NSSAI, Requested NSSAI, Allowed NSSAI, Pending NSSAI, or rejected S-NSSAIs.

For example, the terminal 100 that has received the allowed slice and/or the rejected slice from the AMF 120 may determine an event subscription for slice availability for one or more S-NSSAIs included in the received rejected slice. In this case, the slice availability subscription request message may include one or more pieces of S-NSSAI information that is the target to the slice availability event subscription that the terminal intends to request from among the rejected S-NSSAIs.

As another example, the terminal 100 may include the slice availability subscription request in the Registration Request message in step 410 and transmit the Registration Request message. In this case, the Registration Request message may include S-NSSAI information, which is a target to the slice availability event subscription that the terminal intends to request. In addition, the S-NSSAI information included in the Registration Request message may be included in at least one of Configured NSSAI, Requested NSSAI, Allowed NSSAI, Pending NSSAI, or rejected S-NSSAIs. In this case, since step 424 is performed in step 410, an additional message in step 424 may not occur.

In step 426, the AMF 120 may store the slice availability event subscription request received from the terminal 100 and slice information (S-NSSAI) that is a target to the event subscription request. The S-NSSAI that the terminal 100 is interested in may be currently unavailable. The AMF 120 may monitor the availability of the S-NSSAI that the terminal 100 is interested in. The AMF 120 may deliver a notification message to the terminal when the S-NSSAI is available.

In step 428, the AMF 120 may determine that the S-NSSAI that the terminal 100 is interested in is currently available. For example, the current location of the terminal may be changed due to the movement of the terminal 100. For example, the terminal that has performed steps 410 to 424 at the location TA3 may move thereafter and be located at TA2.

The AMF 120 may detect a change in the location of the terminal. For example, the AMF 120 may request and receive current location information (e.g., TAI, Cell Identity, etc.) of the terminal from the base station 110.

The AMF 120 may determine that the S-NSSAI that the terminal 100 is interested in is currently available, based on the current location information of the terminal. For example, the AMF may identify that at least some (e.g., S-NSSAI 1) of the slices (the corresponding slice information may be stored in the AMF as UE context) to which the terminal subscribes to the slice availability event in step 424 is available at the current location TA2 of the terminal. Accordingly, the AMF may determine to transmit a notification message to the terminal 100 because the slice (e.g., S-NSSAI 1) to which the terminal subscribes to the slice availability event can be supported at the current location.

The notification message that the AMF 120 transmits to the terminal may take various forms. For example, because the slice (e.g., S-NSSAI 1) to which the UE subscribes to the slice availability event can be supported at the current location, the AMF 120 may decide to include the corresponding slice in the allowed slice. In addition, the AMF may determine an RA (e.g., a second RA) to which an allowed slice is applicable. For example, the AMF may include S-NSSAI 1 and S-NSSAI 2 in the second allowed slice, and the second RA may be constituted with the TAs capable of supporting all S-NSSAI included in the allowed slice. In this case, the second allowed slice may include S-NSSAI 1 and S-NSSAI 2, and the second RA may include TA1 and TA2. TA3 may not be included in the second RA because the TA3 does not support S-NSSAI 1. Since S-NSSAI 1 included in the first rejected slice is included in the second allowed slice, the AMF may determine a new rejected slice (e.g., the second rejected slice). That is, the AMF may exclude the S-NSSAI 1 included in the first rejected slice from the rejected slice. In this case, since slice information included in the first allowed slice and the second allowed slice is different, the AMF may transmit a notification message including the second allowed slice to the terminal.

For another example, the AMF 120 may include, in the notification message, only information that the slice (e.g., S-NSSAI 1) to which the terminal subscribes to the slice availability event is supportable at the current location.

The AMF 120 may delete the slice availability event subscription request and the slice information (S-NSSAI) that is the target to the event subscription request received from the terminal 100.

In step 428, the AMF 120 may transmit an availability notification message to the terminal 100. The availability notification message may be transmitted to the terminal through the base station 110.

The terminal 100 that has received the notification message can identify that the slice (e.g., S-NSSAI 1) to which the terminal subscribes to the slice availability event can be supported at the current location.

According to an embodiment of the disclosure, in a case that the notification message includes the second allowed slice and/or the second RA, the terminal 100 may store the received second allowed slice and/or second rejected slice. The terminal 100 may establish a PDU session using the second allowed slice at the second RA location. In this case, steps 430 to 432 may be omitted.

According to another embodiment, in a case that the notification message includes information that the slice (e.g., S-NSSAI 1) to which the terminal subscribes to the slice availability event is supportable at the current location, the terminal 100 may determine to start the terminal registration procedure in order to use the corresponding slice. In this case, steps 430 to 432 may be performed.

In step 430, the terminal 100 may transmit a Registration Request message to the AMF 120. The Registration Request message may include a requested slice (Requested NSSAI) that the terminal intends to use. For example, the requested slice may include information on currently available slices (e.g., S-NSSAI 1) received by the terminal 100 in the notification message of step 428.

In step 432, the AMF 120 may process the Registration Request message received from the terminal. The AMF 120 may determine that the slice requested by the terminal (e.g., S-NSSAI 1) is available at the current location, and include the corresponding slice in the allowed slice. The AMF 120 may transmit a Registration Accept message to the terminal 100. The Registration Accept message may include information on the second allowed slice determined by the AMF 120. In addition, the Registration Accept message may include information on the second rejected slice determined by the AMF 120. For example, as S-NSSAI 1 included in the first rejected slice is included in the second allowed slice, the S-NSSAI 1 may be deleted from the second rejected slice.

Through the procedure illustrated in FIG. 4 according to an embodiment of the disclosure, in a case that the slice (e.g., S-NSSAI 1) that has not been available at the previous location (e.g., TA3) of the terminal becomes available at the current location of the terminal (e.g., TA2), the AMF may transmit a new allowed slice to the terminal. The new allowed slice may be transmitted to the terminal 100 in step 428 or may be transmitted to the terminal 100 through the registration procedure of steps 430 to 432.

Through the procedure illustrated in FIG. 4 according to an embodiment of the disclosure, in a case that a slice (e.g., S-NSSAI 1) that has not been available at the previous location (e.g., TA3) of the terminal becomes available at the current location of the terminal (e.g., TA2), the terminal may receive and use a new allowed slice from the AMF. The new allowed slice may be received in step 428 or through the registration procedure of steps 430 to 432.

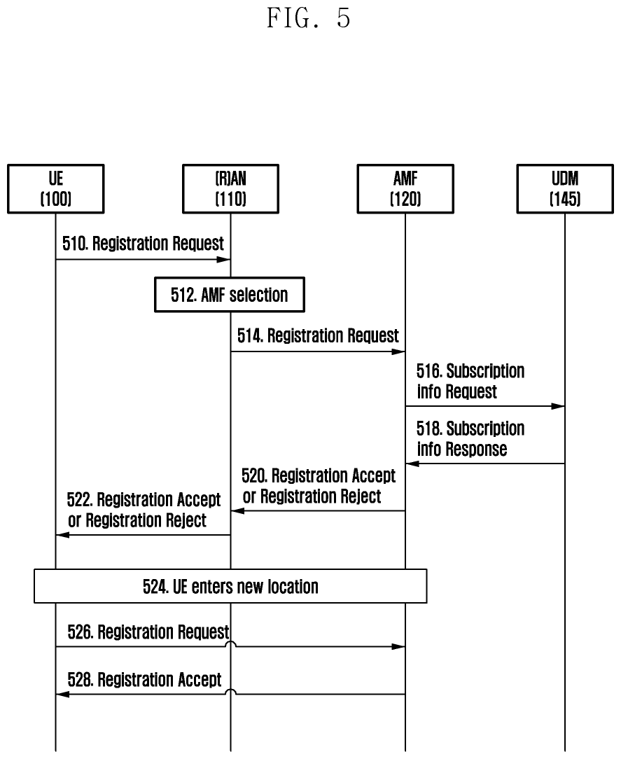

FIG. 5 illustrates a terminal registration procedure according to an embodiment of the disclosure.

Some of the steps of FIG. 5 may be omitted, or two or more steps may be combined and performed as one step. In addition, the operation sequence of FIG. 5 may be changed in some cases.

Referring to FIG. 5, the terminal 100 according to an embodiment of the disclosure may access the base station 110 and perform a registration procedure with the AMF 120.

In step 510, the terminal 100 may access the base station 110 and transmit a Registration Request message to the base station 110. For example, the Registration Request message may include a requested slice (Requested NSSAI, e.g., S-NSSAI 1, S-NSSAI 2) to be used by the terminal. In addition, the Registration Request message may include location information (e.g., Tracking Area Identity (TAI), Cell Identity, etc.) of the terminal.

In step 512, the base station 110 that has received the Registration Request message may select an AMF to transmit the Registration Request, based on the requested slice (Requested NSSAI) received from the terminal 100. For example, the base station 110 may select an AMF capable of supporting the requested slice (Requested NSSAI).

In step 514, the base station 110 may transmit an N2 message to the AMF 120 selected in step 512. For example, the N2 message may include a Registration Request message. Also, the N2 message may include N2 parameters. The N2 parameter may include location information (e.g., tracking area identity (TAI), cell identity, etc.) of the terminal. The AMF 120 may need to obtain terminal subscription information in order to process the Registration Request message.

In step 516, the AMF 120 may request terminal subscription information from the UDM 145. The terminal subscription information request message may include a terminal ID (e.g., SUPI, 5G-GUTI, etc.).

In step 518, the UDM 145 may transmit the terminal subscription information corresponding to the terminal ID to the AMF 120 in response to the request of the AMF 120. The terminal subscription information may include slice information subscribed to by the terminal 100 (subscribed S-NSSAIs). For example, the slice information to which the UE subscribes may include at least one of S-NSSAI 1, S-NSSAI 2, S-NSSAI 3, and S-NSSAI 4.

In step 520, the AMF 120 may determine an allowed slice (Allowed NSSAI) based on at least one of a terminal request slice (Requested NSSAI), a terminal subscription slice (subscribed S-NSSAIs), a terminal access network (3GPP AN), a network slice supported by the base station 110 (S-NSSAI supported by RAN), and an operator policy.

For example, the AMF 120 may identify whether the terminal request slice (e.g., S-NSSAI 1 and S-NSSAI 2) is included in the terminal subscription slice (e.g., S-NSSAI 1, S-NSSAI 2, S-NSSAI 3, and S-NSSAI 4). In addition, the AMF 120 may identify whether the terminal request slice (e.g., S-NSSAI 1 and S-NSSAI 2) is included in a network slice (e.g., S-NSSAIs supported by TA2 includes S-NSSAI 1, S-NSSAI 2, and S-NSSAI 3) supported by the base station 110 at the current location (e.g., TA2) of the terminal.

The AMF 120 may determine the terminal subscription slice (e.g., S-NSSAI 1, S-NSSAI 2, S-NSSAI 3, and S-NSSAI 4) among the terminal request slice (e.g., S-NSSAI 1 and S-NSSAI 2) and the slice (e.g., S-NSSAI 1 and S-NSSAI 2) included in the slices (e.g., S-NSSAI 1, S-NSSAI 2, and S-NSSAI 3) that can be supported at the current location of the terminal to in an allowed slice (e.g., S-NSSAI 1, S-NSSAI 2).

In addition, the AMF 120 may determine the RA during the terminal registration processing procedure. The RA may be constituted with the TA at the current location of the terminal and the TAs adjacent to the current location of the terminal. For example, the RA may be constituted with TA1, TA2, and TA3. The AMF 120 may identify whether the slice (e.g., S-NSSAI 1, S-NSSAI 2) that is determined to be included in the allowed slice is supported by all TAs (e.g., TA1, TA2, TA3) included in the RA. If all TAs included in the RA support the slice determined to be included in the allowed slice, the AMF may finally decide to include the corresponding slice in the allowed slice. In a case that at least one TA included in the RA does not support the slice determined to be included in the allowed slice (for example, in a case that TA3 included in the RA supports S-NSSAI 2 but does not support S-NSSAI 1), the AMF may finally decide not to include the corresponding slice in the allowed slice. In other words, even in a case that a slice is supported by some of the TAs included in the RA (e.g., S-NSSAI 1 is supported by TA1 and TA2), but is not supported by all TAs (e.g., S-NSSAI 1 is not supported by TA3), the AMF may finally decide not to include the corresponding slice in the allowed slice. That is, the finally determined allowed slice may include only the slice supported by all TAs (e.g., S-NSSAI 2). In addition, the AMF may determine to include the slice (e.g., S-NSSAI 1) not included in the allowed slice in the rejected slice (rejected S-NSSAI).

For another example, in a case that the terminal is located in TA3, the AMF 120 may identify whether the terminal requested slice (e.g., S-NSSAI 1 and S-NSSAI 2) is included in the terminal subscribed slice (e.g., S-NSSAI 1, S-NSSAI 2, S-NSSAI 3, and S-NSSAI 4). In addition, the AMF 120 may identify whether the terminal requested slice (e.g., S-NSSAI 1 and S-NSSAI 2) is included in a network slice (e.g., S-NSSAIs supported by TA3 includes S-NSSAI 2) supported by the base station 110 at the current location (e.g., TA3) of the terminal.

The AMF 120 may determine to include a slice, among the terminal requested slice (e.g., S-NSSAI 1 and S-NSSAI 2), into the allowable slice (e.g., S-NSSAI 2), where the slice is included in both (i) the terminal subscribed slice (e.g., S-NSSAI 1, S-NSSAI 2, S-NSSAI 3, and S-NSSAI 4) and (ii) the slice (e.g., S-NSSAI 2) being supportable at the current location of the terminal.

In addition, the AMF 120 may determine the RA during the terminal registration processing procedure. The RA may be constituted with the TAs at the current location of the terminal and the TAs adjacent to the current location of the terminal. For example, the RA may be constituted with TA1, TA2, and TA3. The AMF 120 may identify whether the slice (e.g., S-NSSAI 2) determined to be included in the allowed slice is supported by all TAs (e.g., TA1, TA2, TA3) included in the RA. If all TAs included in the RA support the slice determined to be included in the allowed slice, the AMF may finally decide to include the corresponding slice in the allowed slice. In a case that the slice determined to be included in the allowed slice is not supported by at least one TA included in the RA, the AMF may finally decide not to include the corresponding slice in the allowed slice. That is, the finally determined allowed slice may include only the slice supported by all TAs (e.g., S-NSSAI 2). In addition, the AMF may determine to include a slice (e.g., S-NSSAI 1) not included in the allowed slice in the rejected slice (rejected S-NSSAI).

The AMF 120 may store at least one of the requested slice received from the terminal 100, the allowed slice determined by the AMF, and the rejected slice as the UE context.

In order to describe the embodiment of the disclosure, the embodiment will be described assuming that the terminal is located in TA3 and performs the registration procedure.

The AMF 120 may transmit a response message (Registration Accept or Registration Reject message) in response to the Registration Request message received in step 514 to the terminal 100. The Registration Accept message may include at least one of a first allowed slice (Allowed NSSAI) and a first rejected slice (rejected NSSAI). In addition, the Registration Accept message may include first RA information available for the allowed slice.

For example, the AMF 120 may include S-NSSAI information supported by each TA into the Registration Accept message. As an example, at least one S-NSSAI included in the first allowed slice and/or the first rejected slice may include supportable TA information.

For example, the AMF 120 may include S-NSSAI information supported by each TA in the Registration Accept message based on the TA included in the RA. The AMF 120 may include information that the S-NSSAI 2 included in the first allowed slice is available in TA1, TA2, and TA3 into the Registration Accept message. The AMF 120 may include information that S-NSSAI 1 included in the first rejected slice is available in TA1 and TA2 into the Registration Accept message. And/or, the AMF 120 may include information that the S-NSSAI 1 included in the first rejected slice is not available in TA3 into the Registration Accept message.

For another example, the AMF 120 may include S-NSSAI information supported for each TA in the Registration Accept message even for TAs not included in the RA. As an example, the AMF 120 may include information that S-NSSAI 2 included in the first allowed slice is available in TA4 into the Registration Accept message. And/or, the AMF 120 may include information that the S-NSSAI 2 included in the first allowed slice is not available in TA5 into the Registration Accept message. And/or, The AMF 120 may include information that S-NSSAI 1 included in the first rejected slice is available in TA4 into the Registration Accept message. And/or, the AMF 120 may include information that the S-NSSAI 1 included in the first rejected slice is not available in TA5 into the Registration Accept message.

If there is no slice available to the terminal, that is, if there is no allowed slice, the AMF 120 may transmit a Registration Reject message.

In step 522, the base station 110 may transmit the Registration Accept or Registration Reject message received from the AMF 120 to the terminal 100.

The terminal 100 that has received the Registration Accept message may store the first allowed slice, first rejected slice, and/or S-NSSAI information supported by each TA included in the Registration Accept message. The terminal 100 may establish a PDU session using the first allowed slice at the first RA location.

In step 524, the current location of the terminal may be changed due to the movement of the terminal 100. For example, the terminal that has performed the Registration Request procedure in steps 510 to 522 at the location TA3 may move thereafter and be located at TA2.

The terminal 100 may determine slice information available at the current location based on the current location information (e.g., TA2) of the terminal and information received from the AMF 120. For example, the terminal 100 cannot use S-NSSAI 1 because it is not included in the first allowed slice, but the terminal 100 may identify that S-NSSAI 1 is a slice that can be supported in TA2. Accordingly, the terminal 100 may decide to perform the registration procedure of steps 526 to 528 in order to use the S-NSSAI 1 available at the current location.

In step 526, the terminal 100 may transmit a Registration Request message to the AMF 120. The Registration Request message may include a requested slice (Requested NSSAI) that the terminal intends to use. For example, the requested slice may include slice information (e.g., S-NSSAI 1) available at the current location of the terminal 100.

In step 528, the AMF 120 may process the Registration Request message received from the terminal. The AMF 120 may determine that the slice (e.g., S-NSSAI 1) requested by the UE is available at the current location, and include the corresponding slice in the allowed slice. The AMF 120 may transmit a Registration Accept message to the terminal 100. For example, the Registration Accept message may include the information of the second allowed slice determined by the AMF 120. In addition, the Registration Accept message may include the information of the second rejected slice determined by the AMF 120. For example, as S-NSSAI 1 included in the first rejected slice is included in the second allowed slice, the S-NSSAI 1 may be deleted from the second rejected slice.

Through the procedure illustrated in FIG. 5 according to an embodiment of the disclosure, in a case that the slice (e.g., S-NSSAI 1) that has not been available at the previous location (e.g., TA3) of the terminal becomes available at the current location of the terminal (e.g., TA2), the AMF may transmit a new allowed slice to the terminal 100. The new allowed slice may be transmitted to the terminal 100 through the registration procedure of steps 526 to 528.

Through the procedure illustrated in FIG. 5 according to an embodiment of the disclosure, in a case that the slice (e.g., S-NSSAI 1) that has not been available at the previous location (e.g., TA3) of the terminal becomes available at the current location of the terminal (e.g., TA2), the terminal may receive a new allowed slice from the AMF and use the received new allowed slice. The new allowed slice may be received through the registration procedure of steps 526 to 528.

The above-described procedures of FIGS. 3 to 5 may be performed respectively, or two or more procedures may be combined with each other and performed. In addition, some procedures may be performed in substitution for each other.

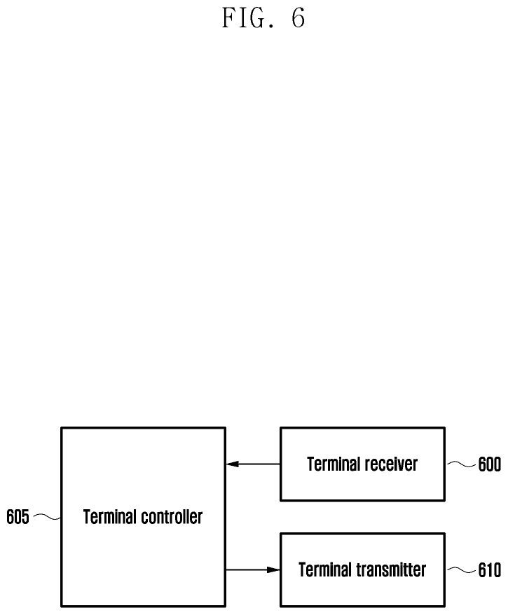

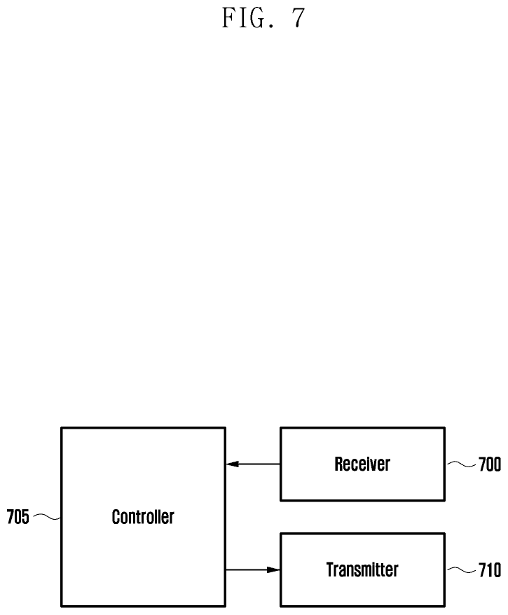

The above-described proposed method and/or embodiments of the disclosure and the signaling procedure illustrated in FIGS. 3 to 5 may be performed by a terminal or a network device described with reference to FIG. 6 or 7 below.

FIG. 6 illustrates a view of a structure of a terminal in a wireless communication system according to an embodiment of the disclosure.

Referring to FIG. 6, the UE may include a transceiver referring to a terminal receiver 600 and a terminal transmitter 610, a memory (not shown), and a terminal controller (or a processor) 605. The terminal transceiver 600, 610, the memory, and the terminal controller 605 may operate according to the communication method of the terminal described above. However, the components of the terminal are not limited thereto. For example, the terminal may include more or fewer components than those described above. In addition, the transceiver, the memory, and the processor may be implemented as a single chip.

The transceiver may transmit or receive a signal to or from other network entities. Here, the signal may include control information and data. In this regard, the transceiver may be constituted with a RF transmitter for up-converting and amplifying a frequency of a transmitted signal, a RF receiver for amplifying low-noise and down-converting a frequency of a received signal, and the like. However, this is only an example of the transceiver and components of the transceiver are not limited to the RF transmitter and the RF receiver. Also, the transceiver may receive and output, to the processor, a signal through a radio channel, and transmit a signal output from the processor through the radio channel.

The memory may store a program and data required for operations of the terminal. Also, the memory may store the control information or data included in the signal transmitted and received by the terminal. The memory may be a storage medium, such as read-only memory (ROM), random access memory (RAM), a hard disk, a compact disc read only memory (CD-ROM), and a digital versatile disc (DVD), or a combination of storage media. Also, there may be a plurality of the memories.

Also, the controller 605 may control a series of processes such that the terminal operates according to an embodiment of the disclosure described above. For example, the controller may be one or more processors, and the controller may execute a program stored in the memory to control the components of the terminal.

FIG. 7 illustrates a view of a structure of a network entity in a wireless communication system according to an embodiment of the disclosure.

The network entity of the disclosure is a concept including a network function according to a system implementation. The network entity may be any one of a base station (RAN), AMF, SMF, UPF, PCF, NSACF, UDM, or UDR.

Referring to FIG. 7, the network entity according to one embodiment of the disclosure may include a transceiver referring to a receiver 700 and a transmitter 710, a memory (not shown), and a controller 705 (or a processor). The transceiver 700, 710, the memory, and the controller 705 may operate according to a communication method of the network entity described above. However, the components of the network entity are not limited thereto. For example, the network entity may include more or fewer components than those described above. In addition, the transceiver, the memory, and the processor may be implemented as a single chip.

The transceiver may transmit or receive a signal to or from the terminal and/or other network entities. Here, the signal may include control information and data. In this regard, the transceiver may be constituted with a RF transmitter for up-converting and amplifying a frequency of a transmitted signal, a RF receiver for amplifying low-noise and down-converting a frequency of a received signal, and the like. However, this is only an example of the transceiver and components of the transceiver are not limited to the RF transmitter and the RF receiver. Also, the transceiver may receive and output, to the processor, a signal through a radio channel, and transmit a signal output from the processor through the radio channel.

The memory may store a program and data required for operations of the network entity. Also, the memory may store the control information or data included in the signal transmitted and received by the network entity. The memory may be a storage medium, such as read-only memory (ROM), random access memory (RAM), a hard disk, a CD-ROM, and a DVD, or a combination of storage media. Also, there may be a plurality of the memories.

The controller 705 may control a series of processes such that the network entity operates according to an embodiment of the disclosure described above. For example, the controller may be one or more processors, and the controller may execute a program stored in the memory to control the components of the network entity.

According to an embodiment of the disclosure, a network entity (e.g., AMF) may monitor whether a location of the terminal is changed in units of TAs and notify the terminal when S-NSSAI, which was not previously allowed, becomes available.

Further, according to an embodiment of the disclosure, the terminal may request information on a slice to be monitored to a network entity, and update slice information based thereon.

Further, according to an embodiment of the disclosure, TA information related to S-NSSAI may be configured in various ways, and slice information may be delivered in units of TAs to enable efficient slice management.

The effects obtainable in the disclosure are not limited to the above-mentioned effects, and other effects not mentioned herein will be clearly understood from the following description by those skilled in the art to which the disclosure belongs.

The methods according to various embodiments described in the claims or the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the disclosure as defined by the appended claims and/or disclosed herein.

The programs (software modules or software) may be stored in non-volatile memories including a RAM and a flash memory, a ROM, an electrically erasable programmable ROM (EEPROM), a magnetic disc storage device, a CD-ROM, DVDs, other type optical storage devices, or a magnetic cassette. Alternatively, any combination of some or all of the memory devices may form a memory in which the program is stored. Further, a plurality of such memories may be included in the electronic device.

In addition, the programs may be stored in an attachable storage device which may access the electronic device through communication networks such as the Internet, Intranet, a local area network (LAN), a wide LAN (WLAN), and a storage area network (SAN) or a combination thereof. Such a storage device may access the electronic device via an external port. Further, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for convenience of description, and the disclosure is not limited by elements expressed in the singular or the plural. Therefore, either an element expressed in the plural may also include a single element or an element expressed in the singular may also include multiple elements.

The embodiments of the disclosure described and shown in the specification and the drawings have been presented to easily explain the technical contents of the disclosure and help understanding of the disclosure, and are not intended to limit the scope of the disclosure. That is, it will be apparent to those skilled in the art that other modifications and changes may be made thereto on the basis of the technical idea of the disclosure. Further, the above respective embodiments may be employed in combination, as necessary. For example, one embodiment of the disclosure may be partially combined with other embodiments to operate a network entity and a terminal.

In the drawings in which methods of the disclosure are described, the order of the description does not always correspond to the order in which steps of each method are performed, and the order or relationship between the steps may be changed or the steps may be performed in parallel.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a terminal in a wireless communication system, the method comprising:
transmitting, to a network entity, a first message for requesting a registration with a network;
receiving, from the network entity, a second message in response to the first message, the second message including information on a tracking area (TA) associated with network slice selection assistance information (NSSAI);
identifying single NSSAI (S-NSSAI) to request based on the second message and location information of the terminal; and
transmitting, to the network entity, a third message including the identified S-NSSAI.

2. The method of claim 1,
wherein the identified S-NSSAI is one of rejected S-NSSAIs for a registration area of the terminal, and
wherein the third message is transmitted in case that a location of the terminal is changed in the registration area so that the identified S-NSSAI becomes available in at least one TA in the registration area.

3. The method of claim 1, wherein the second message further comprises information indicating that a S-NSSAI included in rejected NSSAI is available in at least one TA within a registration area of the terminal.

4. The method of claim 1, wherein the information on TA associated with NSSAI includes at least one of information on a first TA in which a S-NSSAI included in rejected NSSAI is available or information on a second TA in which the S-NSSAI included in rejected NS SAI is not available.

5. The method of claim 1, wherein the information on TA associated with NSSAI includes at least one of information on a third TA in which a S-NSSAI included in allowed NSSAI is available or information on a fourth TA in which the S-NSSAI included in allowed NSSAI is not available.

6. A method performed by a network entity in a wireless communication system, the method comprising:
receiving, from a terminal, a first message for requesting a registration with a network;
transmitting, to the terminal, a second message in response to the first message, the second message including information on a tracking area (TA) associated with network slice selection assistance information (NSSAI); and
receiving, from the terminal, a third message including a single NSSAI (S-NSSAI) to request,
wherein the S-NSSAI is identified based on the second message and location information of the terminal.

7. The method of claim 6,
wherein the identified S-NSSAI is one of rejected S-NSSAIs for a registration area of the terminal, and
wherein the third message is received in case that a location of the terminal is changed in the registration area so that the S-NSSAI becomes available in at least one TA in the registration area.

8. The method of claim 6, wherein the second message further comprises information indicating that a S-NSSAI included in rejected NSSAI is available in at least one TA within a registration area of the terminal.

9. The method of claim 6, wherein the information on TA associated with NSSAI includes at least one of information on a first TA in which a S-NSSAI included in rejected NSSAI is available or information on a second TA in which the S-NSSAI included in rejected NS SAI is not available.

10. The method of claim 6, wherein the information on TA associated with NSSAI includes at least one of information on a third TA in which a S-NSSAI included in allowed NSSAI is available or information on a fourth TA in which the S-NSSAI included in allowed NSSAI is not available.

11. A terminal in a wireless communication system, the terminal comprising:
a transceiver; and
a processor coupled with the transceiver and configured to:
transmit, to a network entity via the transceiver, a first message for requesting a registration with a network,
receive, from the network entity via the transceiver, a second message in response to the first message, the second message including information on a tracking area (TA) associated with network slice selection assistance information (NSSAI),
identify single NSSAI (S-NSSAI) to request based on the second message and location information of the terminal, and
transmit, to the network entity via the transceiver, a third message including the identified S-NSSAI.

12. The terminal of claim 11,
wherein the identified S-NSSAI is one of rejected S-NSSAIs for a registration area of the terminal, and
wherein the third message is transmitted in case that a location of the terminal is changed in the registration area so that the identified S-NSSAI becomes available in at least one TA in the registration area.

13. The terminal of claim 11,
wherein the second message further comprises information indicating that a S-NSSAI included in rejected NSSAI is available in at least one TA within a registration area of the terminal, and
wherein the information on TA associated with NSSAI includes at least one of information on a first TA in which a S-NSSAI included in rejected NS SAI is available, information on a second TA in which the S-NSSAI included in rejected NSSAI is not available, information on a third TA in which a S-NSSAI included in allowed NSSAI is available, or information on a fourth TA in which the S-NSSAI included in allowed NSSAI is not available.

14. A network entity in a wireless communication system, the network entity comprising:
a transceiver; and
a processor coupled with the transceiver and configured to:
receive, from a terminal via the transceiver, a first message for requesting a registration with a network,
transmit, to the terminal via the transceiver, a second message in response to the first message, the second message including information on a tracking area (TA) associated with network slice selection assistance information (NSSAI), and
receive, from the terminal via the transceiver, a third message including a single NSSAI (S-NSSAI) to request,
wherein the S-NSSAI is identified based on the second message and location information of the terminal.

15. The network entity of claim 14,
wherein the identified S-NSSAI is one of rejected S-NSSAIs for a registration area of the terminal,
wherein the third message is received in case that a location of the terminal is changed in the registration area so that the S-NSSAI becomes available in at least one TA in the registration area, and
wherein the information on TA associated with NSSAI includes at least one of information on a first TA in which a S-NSSAI included in rejected NSSAI is available, information on a second TA in which the S-NSSAI included in rejected NSSAI is not available, information on a third TA in which a S-NSSAI included in allowed NSSAI is available, or information on a fourth TA in which the S-NSSAI included in allowed NSSAI is not available.
